(19) United States
(12) Patent Application Publication
(10) Pub. No.: US 2017/0016100 A1
(43) Pub. Date: Jan. 19, 2017

(54) HIGH-STRENGTH HOLLOW STEEL PIPE MATERIAL HAVING ENHANCED CORROSION RESISTANCE

(71) Applicant: HYUNDAI MOTOR COMPANY, Seoul (KR)

(72) Inventor: Dong-Lim SEO, Seoul (KR)

(73) Assignee: HYUNDAI MOTOR COMPANY, Seoul (KR)

(21) Appl. No.: 14/956,571

(22) Filed: Dec. 2, 2015

(30) Foreign Application Priority Data
Jul. 16, 2015 (KR) 10-2015-0100977

(51) Int. Cl. C22C 38/54; B60G 21/055; C22C 38/04; C22C 38/02; C22C 38/48; C22C 38/44

(52) U.S. Cl. CPC C22C 38/54; C22C 38/48; C22C 38/44; C22C 38/04; C22C 38/02; B60G 21/055

(57) ABSTRACT

Disclosed is a high-strength hollow steel pipe material. The high-strength hollow steel pipe material includes Fe as a main ingredient, 0.30 to 0.40% by weight of C, 0.10 to 0.40% by weight of Si, 1.10 to 1.60% by weight of Mn, 0.20 to 0.40% by weight of Cr, 0.50 to 1.00% by weight of Ni and 0.001 to 0.005% by weight of B, the high-strength hollow steel pipe material having increased material corrosion fatigue life, compared to conventional steel pipe materials, by enhancing elongation and corrosion resistance while reinforcing strength through increase of the amounts of C and Ni conventionally added and addition of Nb and Mo as new materials.

### CROSS-REFERENCE TO RELATED APPLICATIONS

This application claims the benefit of Korean Patent Application No. 10-2015-0100977, filed on Jul. 16, 2015, the contents of which are incorporated herein by reference in its entirety.

### FIELD

The present disclosure relates to a high-strength steel pipe material having increased material corrosion fatigue life.

### BACKGROUND

The statements in this section merely provide background information related to the present disclosure and may not constitute prior art.

Recently, mileage enhancement through weight reduction in transport means such as vehicles and airplanes is desired for energy consumption reduction and carbon dioxide emission reduction for environmental reasons. In particular, in vehicle industries, decreasing the energy amount required per unit distance by reducing the weight of components to enhance mileage has been pursued.

When steel components are reduced in weight to reduce the weight of vehicle components, issues may occur in regard to passenger safety due to a limited supportable load per unit weight. Therefore, research into corrosion resistance enhancement is underway in order satisfy a trend toward high strength of vehicle components, and, in a stabilizer or spring material used in vehicles, enhancement of strength, elongation and corrosion fatigue life has been pursued.

Weight-reduction of vehicles becomes possible through hollowing and strength increases of steel materials. However, as the strength of materials is increased, sensitivity to corrosion after chipping or painting, exfoliation due to collision with gravel, etc. is increased, and strength is decreased and progression to fracture after destruction is accelerated. At present, to address such issues, dual coating, etc. in corrosion-vulnerable areas is used, but material costs such as painting, etc. are increased.

Meanwhile, recently, strength increases and weight reduction of components have been employed to realize high performance, high torque and high efficiency of vehicles. In this regard, the weight of steel for suspension components such as a stabilizer or a spring should be reduced under conventional vehicle load and corrosion conditions, and thus, strength and corrosion resistance of materials should be considered. In particular, corrosion fatigue life of a stabilizer may be reduced due to exposure to corrosive environments during driving when materials are hollowed.

In conventional technology, a general material (ST20B) or a high-strength material (ST23MnB) for strength increase of hollow steel pipes is used to achieve weight reduction of a step bar or a stabilizer. More particularly, in a conventional material, Fe is used as a main ingredient and C, Si, Mn, Cr, Ni and B are included. In the case of a high-strength material, Fe is used as a main ingredient and C, Si, Mn, Cr and B are included.

A conventional general material has a tensile strength of 120 kgf/mm² while a high-strength material has a tensile strength of 150 kgf/mm², which is approximately 25% higher than that in the general material. However, the high-strength material has reduced elongation and increased corrosion sensitivity, whereby components experience premature failure.

### SUMMARY

The present disclosure provides a high-strength hollow steel pipe material which may increase corrosion resistance while improving strength and elongation to address premature failure of components due to corrosion sensitivity increases.

In accordance with the present disclosure, a high-strength hollow steel pipe material having enhanced corrosion resistance is provided, the high-strength hollow steel pipe material including Fe as a main ingredient, 0.30 to 0.40% by weight of C, 0.10 to 0.40% by weight of Si, 1.10 to 1.60% by weight of Mn, 0.20 to 0.40% by weight of Cr, 0.50 to 1.00% by weight of Ni and 0.001 to 0.005% by weight of B.

The high-strength hollow steel pipe material may further include Mo. Here, the amount of the Mo may be 0.20 to 0.40% by weight.

The high-strength hollow steel pipe material may further include Nb. Here, the amount of the Nb may be 0.05 to 0.10% by weight.

The high-strength hollow steel pipe material may further include Mo and Nb. Here, the amount of the Mo may be 0.20 to 0.40% by weight and the amount of the Nb may be 0.05 to 0.10% by weight.

In accordance with another aspect of the present disclosure, there is provided a hollow stabilizer bar 1 manufactured from the high-strength hollow steel pipe material according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a graph comparing material fatigue test results for a high-strength hollow steel pipe material according to one form of the present disclosure, and a general material and a high-strength material as conventional technologies; and

FIG. 2 illustrates a perspective view of a vehicle body equipped with a stabilizer bar 1 manufactured using a high-strength hollow steel pipe material according to a form of the present disclosure.

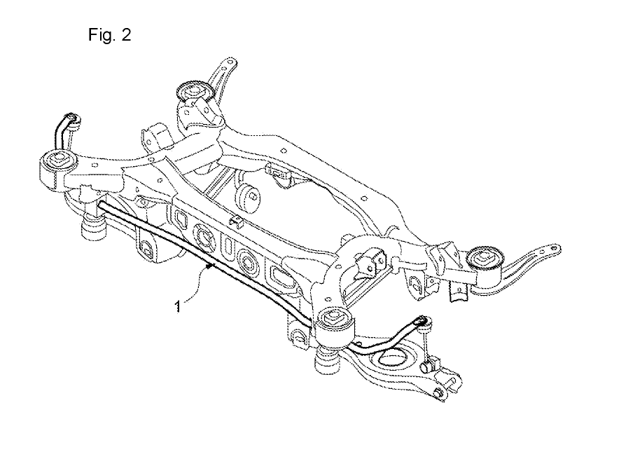

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The present disclosure provides a hollow steel pipe material, which may be used a stabilizer bar 1, a coil spring, etc., having a tensile strength increased by 20%, elongation increased by 10%, and a corrosion fatigue life increased by 30% or more due to corrosion resistance reinforcement, compared to conventional high-strength materials.

In order to enhance mechanical properties, conventional elongation or more should be maintained along with strength increase. Weight reduction and strength margin of components are provided due to carbide generation, hardenability enhancement and refinement of crystal grains through the addition of carbon (C), in a larger amount than a conventionally used amount, and molybdenum (Mo). In addition, when niobium (Nb) or molybdenum (Mo) is added to maintain elongation to an equal state to a conventional elongation, impact toughness reduction according to strength increase through refinement of crystal grains may be accomplished.

In addition, in order to increase corrosion resistance of a high-strength hollow steel pipe material, corrosion resistance should be enhanced and material corrosion fatigue life should be increased. Accordingly, corrosion resistance may be enhanced by inhibiting growth of a corroded pit (when a portion of a protective film of a metal surface under corrosive environments is peeled off, the peeled portion is intensively corroded or a hole is generated) through addition of nickel (Ni). In addition, crystal grains are refined due to addition of Nb and thus material corrosion fatigue is increased.

Hereinafter, effects due to addition of elements of each alloy are examined in detail.

In regard to an alloy in which weight ratios of elements are increased, compared to conventional alloys, effects due to addition of C and effects due to addition of Ni are examined. With increasing amount of C as one of five basic elements of steel, strength is increased, but toughness relatively is decreased. Accordingly, it is desired to properly maintain the amount of C considering other alloy ingredients. Ni suppresses growth of a corroded pit when steel is exposed to corrosive environments, thus having excellent corrosion resistance enhancement effects. Accordingly, Ni along with Cr may be used as a main alloy added to stainless steel.

Molybdenum (Mo) and niobium (Nb), which are not conventionally used, are newly added in the present disclosure. Here, effects of Molybdenum (Mo) and niobium (Nb) are examined. Mo enhances hardenability of steel and contributes to strength increases through carbide formation. When Mo is added in a proper amount, temper embrittlement is inhibited and there are effects in refining crystal grains. Nb decreases temper embrittlement, and, when a large amount of Nb is added, hardenability is decreased. Accordingly, the amount of Nb is generally limited to 0.10% by weight or less.

Effects according to addition of alloy elements are examined above. Hereinafter, principles of material characteristic enhancement through addition of alloy as the basis for selection of alloy ingredients are examined.

1. Nickel (Ni)

When Ni is added, growth of a corroded pit of a material surface is suppressed and thus corrosion resistance is enhanced. When Ni is added in an amount of less than 0.5% by weight, growth of a corroded pit is not suppressed and thus corrosion resistance is decreased. On the other hand, when Ni is added in an amount of greater than 1.0% by weight, corrosion resistance enhancement effects are slight and thus manufacturing costs increase. In Table 1 below, when other ingredients are the same, differences in depths of corroded pits according to an addition amount of Ni are summarized.

TABLE 1

| Ni content | Depth of corroded |
|---|---|
| (% by weight) | pit (μm) |
| 0.20 | 470 |
| 0.40 | 390 |
| 0.60 | 260 |
| 0.80 | 140 |
| 1.00 | 90 |
| 1.20 | 80 |

As shown in Table 1, it can be confirmed that, with increasing Ni content, the depths of corroded pits of a material surface are decreased. However, when the content of Ni is 0.4% by weight or less, effects according to addition of Ni are slight. On the other hand, when the content of Ni is greater than 0.8% by weight, effects according to addition of Ni are slight and thus manufacturing costs increase. Accordingly, efficiency is increased when Ni is added in an amount of 0.6 to 0.8% by weight. However, when ease of material management and manufacturing costs are considered, a weight ratio of Ni is in one form0.5 to 1.0% by weight.

2. Molybdenum (Mo)

When Mo is added, coarsening of initial austenite is inhibited.

TABLE 2

| Content of Mo | Size of initial austenite | |
|---|---|---|
| (% by weight) | crystal grain | Note |
| 0 | 5 | Crystal grain is large |
| 0.20 | 2 to 3 | Crystal grain becomes |
| | | small |
| 0.40 | 1 to 2 | Crystal grain becomes |
| | | small |
| 0.60 | 1 to 2 | Crystal grain does not |
| | | become small |
| 0.80 | 1 to 2 | Crystal grain does not |
| | | become small |
| 1.00 | 1 to 2 | Crystal grain does not |
| | | become small |

In Table 2, when other ingredients are the same, the sizes of initial austenite crystal grains according to an addition amount of Mo are summarized. As shown in Table 2, it can be confirmed that, with increasing additional amounts of Mo, crystal grains of austenite become small. However, it can be confirmed that, even when the addition amount of Mo is greater than 0.4% by weight, effects according to Mo addition are not exhibited. Accordingly, efficiency is higher when Mo is added in an amount of 0.2% by weight or more and change in efficiencies is slight when Mo is added in an amount of 0.4% by weight or more, whereby a weight ratio of Mo is in one form0.2 to 0.4% by weight when manufacturing costs are considered.

3. Niobium (Nb)

When Nb is added, decrease of toughness is inhibited and corrosion fatigue life of a material is enhanced, due to refinement of crystal grains. This can be shown through Mathematical Equation 1 below.

σ₀=σᵢ+K′d^{-1/2} [Mathematical Equation 1]
σ₀=YIELD STRESS, TOUGHNESS
σ₁=DISLOCATION MOBILITY DISTURBANCE FRICTION COEFFICIENT
K′=BARRIER INTEGRATION CONSTANT OF DISLOCATION
d=DIAMETER OF CRYSTAL GRAIN

It can be confirmed that, through Mathematical Equation 1 as a Hall-Petch equation, strength and toughness are increased with decreasing crystal grain diameter. Here, it can be confirmed that development steps of cracks are increased with decreasing crystal grain diameter and thus crack progression becomes difficult, whereby corrosion fatigue life is extended.

In addition, in Table 3 below, strength and elongation are compared according to addition amounts of Nb. As shown in Table 3 below, it can be confirmed that elongation varies different according to addition amounts of Nb.

In the case of TEST #1, 0.02% by weight of Nb is added. As a result, strength is 1,793 MPa and elongation is 10.3%.

In the case of TEST #2, 0.06% by weight of Nb is added. As a result, strength is 1,802 MPa and elongation is 14.9%. Accordingly, strength is not greatly different, but elongation is greatly increased.

In the case of TEST #3, 0.12% by weight of Nb is added. As a result, strength is 1,831 MPa and elongation is 15.0%.

Through Table 3, it can be confirmed that, in TEST #3 in which 0.12% by weight of Nb is added, enhancement of strength and elongation is slight, when compared to TEST #2 in which 0.06% by weight of Nb is added. Accordingly, the amount of Nb is in one form0.05 to 0.10% by weight, when mechanical properties and manufacturing costs are considered.

TABLE 3

| | Chemical ingredients | Strength | Elongation |
|---|---|---|---|
| Classification | (% by weight) | (MPa) | (%) |
| TEST #1 | C: 0.35-Si: 0.27-Mn: 1.32-Cr: 0.35- | 1,793 | 10.3 |
| | Ni: 0.71-B: 0.002-Mo: 0.3-Nb: 0.02 | | |
| TEST #2 | C: 0.34-Si: 0.29-Mn: 1.40-Cr: 0.35- | 1,802 | 14.9 |
| | Ni: 0.73-B: 0.002-Mo: 0.3-Nb: 0.06 | | |
| TEST #2 | C: 0.35-Si: 0.30-Mn: 1.37-Cr: 0.37- | 1,831 | 15.0 |
| | Ni: 0.70-B: 0.003-Mo: 0.3-Nb: 0.12 | | |

In Table 4 below, strengths of the high-strength hollow steel pipe material according to the present disclosure and materials according to conventional technologies are summarized. In the conventional technologies, the general material generally includes C, Si, Mn, Cr, Ni and B, and the high-strength material generally includes C, Si, Mn, Cr and B.

In the high-strength hollow steel pipe material according to the present disclosure, weight ratios of C and Ni are increased, compared to the conventional technologies, and Mo and Nb are newly added.

In the high-strength hollow steel pipe material according to the present disclosure, C is preferably present in an amount of 0.30 to 0.40% by weight. In the high-strength steel pipe material, strength is decreased when the amount of C is less than 0.30% by weight, and ductility is decreased when the amount of C is greater than 0.40% by weight.

In addition, in the high-strength hollow steel pipe material of the present disclosure, the amount of Ni is in one form0.50 to 1.00% by weight. In the high-strength steel pipe material, suppression effects for corroded pit growth are decreased and thus corrosion resistance is decreased when the amount of Ni is less than 0.50% by weight, and it is difficult to deal with materials and manufacturing costs increase when the amount of Ni is greater than 1.00% by weight.

In addition, in the high-strength hollow steel pipe material of the present disclosure, Mo is in one form added in an amount of 0.20 to 0.40% by weight. In the high-strength hollow steel pipe material, when the amount of Mo is less than 0.20% by weight, hardenability of steel is decreased and thus carbide is not formed, thereby decreasing strength. On the other hand, when the amount of Mo is greater than 0.40%, hardenability is not significantly increased and manufacturing costs increase.

In addition, in the high-strength hollow steel pipe material according to the present disclosure, Nb is in one form added in an amount of 0.05 to 0.10% by weight. In the high-strength hollow steel pipe material, the amount of Nb is less than 0.05% by weight, crystal grains are not refined and thus toughness is decreased, thereby increasing material corrosion fatigue life. On the other hand, when the amount of Nb is greater than 0.10% by weight, elongation enhancement effects are slight and manufacturing costs increase.

Referring to Table 4, it can be confirmed that the materials according to conventional technologies have a strength of 120 K to 150 K, but the high-strength hollow steel pipe material according to the present disclosure has an enhanced strength of 180 K.

TABLE 4

| Classification | | C | Si | Mn | Cr | Ni | B | Mo | Nb | Note |
|---|---|---|---|---|---|---|---|---|---|---|
| Conventional | General | 0.16 | 0.10 | 0.30 | 0.20 | 0.10 | 0.001 | — | — | About |
| technology | material | to | to | to | to | to | to | | | 120K |
| | (ST20B) | 0.23 | 0.25 | 0.60 | 0.40 | 0.30 | 0.005 | | | strength |
| | High- | 0.19 | 0.40 | 1.10 | 0.10 | — | 0.001 | — | — | About |
| | strength | to | or | to | to | | to | | | 150K |
| | material | 0.25 | less | 1.60 | 0.60 | | 0.005 | | | strength |
| | (ST23MnB) | | | | | | | | | |

| | | | | | | | | | |
|---|---|---|---|---|---|---|---|---|---|
| The present invention | 0.30 | 0.10 | 1.10 | 0.20 | 0.50 | 0.001 | 0.20 | 0.05 | About |
| | to | to | to | to | to | to | to | to | 180K |
| | 0.40 | 0.40 | 1.60 | 0.40 | 1.00 | 0.005 | 0.40 | 0.10 | strength |

As described above, by adding C and Ni in an increased amount, compared to the conventional materials, and by newly adding Nb and Mo to the high-strength hollow steel pipe material according to the present disclosure, mechanical properties (strength and elongation) are increased, i.e., tensile strength is enhanced by 20% and elongation is enhanced by 10%, compared to the conventional high-strength material. In addition, crystal grains of the high-strength hollow steel pipe material according to the present disclosure are refined to about ⅓ (a crystal grain size of 33 μm in the conventional materials is refined to 12 μm in the material according to the present disclosure), and thus, properties of the material are enhanced. Furthermore, in the high-strength hollow steel pipe material according to the present disclosure, fatigue strength is increased by 20% and corrosion fatigue life is increased by 40%, compared to the high-strength material according to the conventional technology.

### Example

Among high-strength steel pipe materials including Fe as a main ingredient, 0.30 to 0.40% by weight of C, 0.10 to 0.40% by weight of Si, 1.10 to 1.60% by weight of Mn, 0.20 to 0.40% by weight of Cr, 0.50 to 1.00% by weight of Ni, 0.001 to 0.005% by weight of B, 0.20 to 0.40% by weight of Mo and 0.05 to 0.10% by weight of Nb, a high-strength steel pipe material, which including Fe as a main ingredient, 0.34% by weight of C, 0.29% by weight of Si, 1.40% by weight of Mn, 0.35% by weight of Cr, 0.73% by weight of Ni, 0.002% by weight of B, 0.3% by weight of Mo and 0.06% by weight of Nb, according to TEST #2 was experimented. Results are as follows.

TABLE 5

| | Tensile strength | Yield strength | Elongation |
|---|---|---|---|
| Steel type | (MPa) | (MPa) | (%) |
| General material: | 1,244 | 1,133 | 14.6 |
| ST20B | | | |
| High-strength | 1,520 | 1,310 | 13.4 |
| material: | | | |
| ST23MnB | | | |
| Example | 1,802 | 1,493 | 14.9 |
| according to the | | | |
| present | | | |
| disclosure(TEST | | | |
| #2) | | | |

In Table 5, properties of materials manufactured under the same conditions as a conventional mass production process are summarized. Through Table 5, it can be confirmed that, in the high-strength hollow steel pipe material according to the present disclosure, tensile strength is increased by 282 MPa or more, compared to the general material or high-strength material according to conventional technology. In addition, it can be confirmed that the high-strength hollow steel pipe material according to the present invention has an elongation of 14.9% while the high-strength material according to conventional technology has an elongation of 13.4%, i.e., the elongation of the high-strength hollow steel pipe material according to the present disclosure is increased, compared to that of the high-strength material according to conventional technology.

In addition, it can be confirmed that, in the high-strength hollow steel pipe material according to the present disclosure, crystals are refined due to addition of Mo and Nb and thus a crystal grain size is 12 μm. In addition, it can be confirmed that, the material of the high-strength hollow steel pipe according to the present disclosure is refined, compared to a crystal grain size of 33 μm of the high-strength material according to conventional technology.

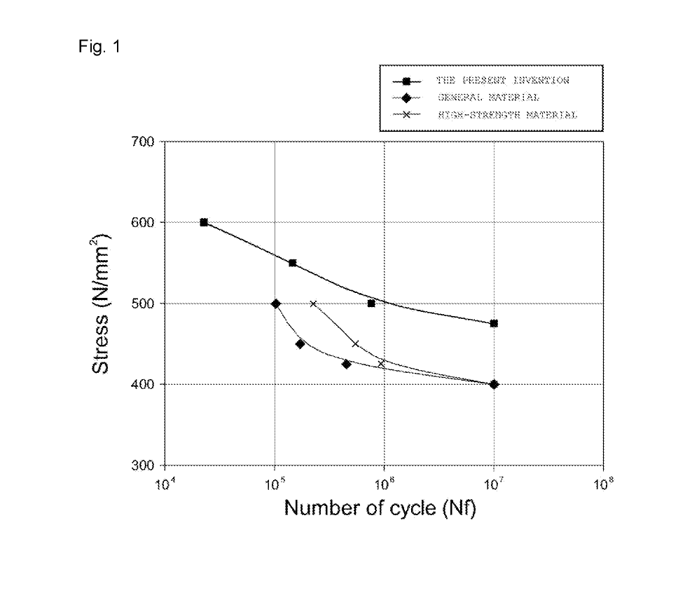

FIG. 1 illustrates material fatigue strength evaluation results. While a fatigue strength of the high-strength material according to conventional technology is 40 K, fatigue strength of the high-strength hollow steel pipe material according to the present disclosure is increased by 20% or more.

In addition, in order to evaluate corrosion fatigue life, a painted film was compulsorily peeled off through gravel-throwing and then, corrosion was generated on a surface by repeatedly spraying/drying a 5% NaCl solution (salt spraying) for 360 hours at 35° C. Subsequently, corrosion fatigue life (durability) was evaluated. Results are summarized in Table 6 below.

TABLE 6

| | | | Example |
|---|---|---|---|
| | | | according to the |
| | Conventional technology | | present |
| | General | High-strength | disclosure(TEST |
| Classification | material | material | #2) |
| First evaluation | 460,759 | 268,073 | 431,102 |
| Second evaluation | 539,302 | 367,950 | 507,894 |
| Third evaluation | 442,668 | 359,007 | 463,552 |
| Average | 480,909 | 331,677 | 467,516 |

Note
97.2% with respect to general material (almost the same)
41% higher with respect to high-strength material

Through Table 6, it can be confirmed that, in the example according to the present disclosure, fatigue life due to corrosion is increased by 41% or more, compared to the high-strength material according to conventional technology.

According to the present disclosure, by manufacturing a stabilizer bar 1 or a coil spring and applying the same to vehicles using the high-strength hollow steel pipe material according to the present disclosure having enhanced strength, elongation and corrosion resistance, corrosion resistance and strength of the vehicles may be enhanced, compared to the case in which the conventional high-strength material is used. Accordingly, corrosion fatigue life of the vehicles is increased, whereby durability is increased and marketability of vehicles may be increased.

As is apparent from the above description, the high-strength hollow steel pipe material according to the present disclosure may enhance tensile strength and elongation, compared to the conventional high-strength material.

In addition, the high-strength hollow steel pipe material according to the present disclosure may enhance corrosion fatigue life and corrosion resistance by refining a crystal grain size.

Furthermore, when a stabilizer bar is manufactured using the high-strength hollow steel pipe material according to the present disclosure, corrosion resistance, strength and corrosion fatigue life are increased, compared to the case in which the conventional high-strength material is used. Accordingly, durability may be enhanced.

Additionally, corrosion resistance of a stabilizer bar may be increased through the present disclosure, which may inhibit field claims for mass-produced vehicles and increase profitability and brand recognition by not using special measures (e.g., dual-coating, etc.) due to conventional corrosion resistance deficiencies.

In addition, as incidental effects of the present disclosure, the high-strength hollow steel pipe material according to the present disclosure may increase safety and provide a longer lifespan of high-strength hollow steel pipes and with broader applicability.

Although the various forms of the present disclosure have been included for illustrative purposes, those skilled in the art will appreciate that various modifications, additions and substitutions are possible, without departing from the scope and spirit of the present disclosure as disclosed in the accompanying claims.

What is claimed is:

1. A high-strength hollow steel pipe material comprising:
Fe as a main ingredient;
0.30 to 0.40% by weight of C;
0.10 to 0.40% by weight of Si;
1.10 to 1.60% by weight of Mn;
0.20 to 0.40% by weight of Cr;
0.50 to 1.00% by weight of Ni; and
0.001 to 0.005% by weight of B.

2. The high-strength hollow steel pipe material according to claim 1, further comprising Mo, wherein an amount of the Mo is 0.20 to 0.40% by weight.

3. The high-strength hollow steel pipe material according to claim 1, further comprising Nb, wherein an amount of the Nb is 0.05 to 0.10% by weight.

4. The high-strength hollow steel pipe material according to claim 1, further comprising Mo and Nb, wherein an amount of the Mo is 0.20 to 0.40% by weight and an amount of the Nb is 0.05 to 0.10% by weight.

5. A hollow stabilizer bar manufactured from the high-strength hollow steel pipe material according to claim 1.
